(19) United States
(12) Patent Application Publication
(10) Pub. No.: US 2003/0160913 A1
(43) Pub. Date: Aug. 28, 2003

(54) Liquid crystal display apparatus and terminal equipment

(75) Inventor: Shunichi Yamashita, Tokyo (JP)

Correspondence Address: FOLEY AND LARDNER, SUITE 500, 3000 K STREET NW, WASHINGTON, DC, 20007, US

(73) Assignee: NEC Infrontia Corporation

(21) Appl. No.: 10/305,350

(22) Filed: Nov. 27, 2002

(30) Foreign Application Priority Data
Nov. 28, 2001 (JP) 362767/2001

(51) Int. Cl. G02F 1/1335

(52) U.S. Cl. 349/96

(57) ABSTRACT

A liquid crystal display apparatus includes an upper substrate having a first alignment layer and a first polarization plate. A lower substrate has a second alignment layer and a second polarization plate. A liquid crystal material is sandwiched between the upper substrate and the lower substrate. The first polarizing plate is arranged such that an up-and-down direction of a screen in the liquid crystal display apparatus becomes its first polarization-axis direction. The second polarizing plate is arranged such that its second polarization-axis direction becomes rectangular for the first polarization-axis direction. The first alignment layer is aligned by rubbing-treatment in the first polarization-axis direction. The second alignment layer is aligned by rubbing-treatment in the second polarization-axis direction.

### BACKGROUND OF THE INVENTION

The present invention relates to a liquid crystal display apparatus and a terminal equipment for improving the visibility.

A liquid crystal display (LCD) panels and methods which can provide increased viewing angle over conventional display is disclosed in U.S. Pat. No. 5,856,857.

Now, the conventional display panel will be described hereinbelow. A panel for a liquid crystal display (LCD) includes a substrate having a plurality of pixel areas defined thereon. A first alignment layer is formed on the substrate, the first alignment layer providing a first pretilt angle for a liquid crystal material. A plurality of second alignment regions is formed on the first alignment layer and are separated from each other with a predetermined spaces between them, the second alignment regions providing a second pretilt angle for the liquid crystal material, respective second alignment regions being separated by a portion of the first alignment layer such that a respective pixel area is covered by the first alignment region and partially covered by a second alignment region. Portions of the first alignment layer and the second alignment regions covering respective adjacent pixel areas have grooves formed therein which are substantially alignment along respective first and second directions. The first and second directions preferably are perpendicular. The pixel areas may be rectangular, and the portion of a respective pixel area covered by a second alignment region may include approximately one-half of the pixel area. The approximately one-half of the pixel area may include a rectangular portion of the pixel area. Preferably, the second pretilt angle is greater than the first pretilt angle.

In the conventional terminal equipment, the liquid crystal display apparatus has been employed in the note type computer and the liquid crystal monitor. For examples in the note type computer, the center of the screen is below the object of the vision of an user (viewing direction) for the screen. Therefore, the viewing direction is above the normal line direction to the screen.

However, the above conventional terminal equipment has been found to have the following problems. When the liquid crystal display apparatus employed in the note type computer and the liquid crystal monitor is used in front of the screen and in the viewing direction except for the viewing direction above the normal line direction to the screen, the viewing angle direction is above the normal line direction to match the vision of the user in front of the screen. This results in the deterioration in the visibility.

### SUMMARY OF THE INVENTION

In light of foregoing, it is an object of the present invention to solve the problems (drawbacks) of the prior art as described above and to provide a liquid crystal display apparatus and a terminal equipment for improving the visibility.

In particular, according to the present invention, A liquid crystal display apparatus includes an upper substrate having a first alignment layer and a first polarization plate. A lower substrate has a second alignment layer and a second polarization plate. A liquid crystal material is sandwiched between the upper substrate and the lower substrate. The first polarizing plate is arranged such that an up-and-down direction of a screen in the liquid crystal display apparatus becomes its first polarization-axis direction. The second polarizing plate is arranged such that its second polarization-axis direction becomes rectangular for the first polarization-axis direction. The first alignment layer is aligned by rubbing-treatment in the first polarization-axis direction. The second alignment layer is aligned by rubbing-treatment in the second polarization-axis direction.

A second liquid crystal molecules in contact with the interface of the second alignment layer are aligned in the second polarization-axis direction.

A polarized light emitted from the lower substrate is transmitted from the lower substrate to the upper substrate while oscillating in a longer axis direction of the second liquid crystal molecules.

A first liquid crystal molecules in contact with the interface of the first alignment layer are aligned such that the first alignment directions of the first liquid crystal molecules are twisted by 90° for the second aligning directions of the first liquid crystal molecules.

The first liquid crystal molecules moves spirally such that a longer axis thereof are twisted by 90° for the second aligning directions In the liquid crystal material.

The first polarization-axis direction, a rubbing treatment direction, and a polarized light oscillating direction are parallel.

The first liquid crystal molecules are arranged with a pretilt angle for the rubbing treatment direction kept.

When the first liquid crystal molecules is raised depending on the pretilt angle, an oscillation of the polarized light becomes to the maximum value at a part in a direction perpendicular to the longer axis direction of the first liquid crystal molecules, the direction being a viewing direction of the liquid crystal display apparatus.

A liquid crystal display apparatus includes an upper substrate having a first alignment layer and a first polarization plate. A lower substrate has a second alignment layer and a second polarization plate. A liquid crystal material is sandwiched between the upper substrate and the lower substrate. The first polarizing plate is arranged such that a direction from lower right to upper left of a screen in the liquid crystal display becomes its first polarization-axis direction. The second polarizing plate is arranged such that its second polarization-axis direction becomes rectangular for the first polarization-axis direction. The first alignment layer is aligned by rubbing-treatment in the first polarization-axis direction. The second alignment layer is aligned by rubbing-treatment in the second polarization-axis direction.

A terminal equipment equipped with a liquid crystal display apparatus include an upper substrate having a first alignment layer and a first polarization plate. A lower substrate having a second alignment layer and a second polarization plate. A liquid crystal material is sandwiched between the upper substrate and the lower substrate. The first polarizing plate is arranged such that an up-and-down direction of a screen in the liquid crystal display apparatus becomes its first polarization-axis direction. The second polarizing plate is arranged such that its second polarization-axis direction becomes rectangular for the first polarization-axis direction. The first alignment layer is aligned by rubbing-treatment in the first polarization-axis direction. The second alignment layer is aligned by rubbing-treatment in the second polarization-axis direction.

### BRIEF DESCRIPTION OF THE DRAWINGS

FIG. 1 is a block diagram showing one preferred embodiment of a liquid crystal display apparatus in accordance with the present invention;

FIG. 2 is an external perspective view showing one preferred embodiment of a terminal equipment equipped with the liquid crystal display apparatus in accordance with the present invention;

FIG. 3 is a block diagram showing one preferred embodiment of an liquid crystal display apparatus in accordance with the present invention;

FIG. 4 shows the rubbing-treatment process by use of the rubbing-treatment apparatus rubbing a first alignment layer formed in an upper substrate of the liquid crystal display equipped with the terminal equipment according to the present invention;

FIG. 5 is a diagram illustrating the operation of a liquid crystal display apparatus in FIG. 1;

FIG. 6 is a diagram illustrating the operation of a liquid crystal display apparatus in FIG. 1; and

FIG. 7 is an external perspective view showing another preferred embodiment of a terminal equipment equipped with the liquid crystal display apparatus in accordance with the present invention;

### DESCRIPTION OF THE PREFERRED EMBODIMENTS

An embodiment of the present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be through and complete, and will fully convey the scope of the invention to those skilled in the art.

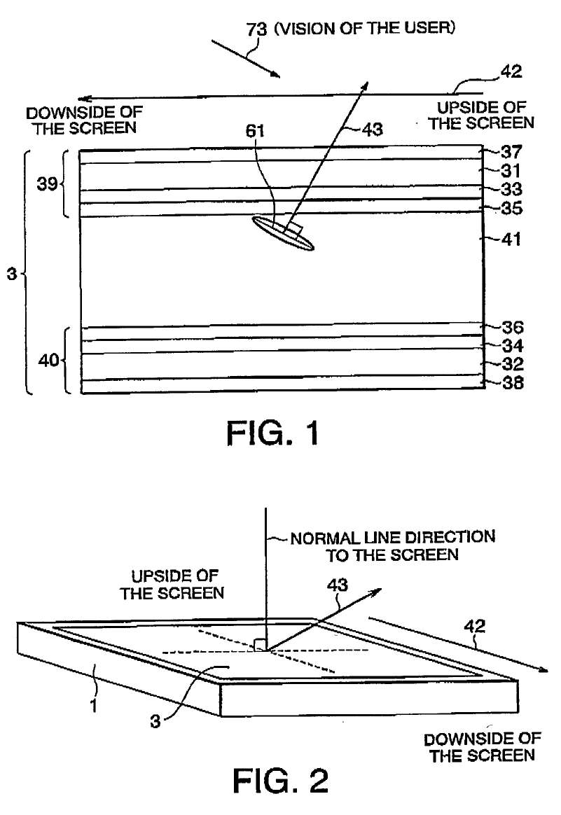

Referring to FIG. 1, a liquid crystal display 3 is used in case the vision of the user (indicated by 73 in FIG. 6) is below the normal line direction to the screen, and is equipped with a terminal equipment 1.

The liquid crystal display 3 comprises an upper substrate 39 and a lower substrate 40. The upper substrate 39 has an upper glass substrate 31, a transparent electrode 33, a first alignment layer 35, and a first polarizing plate 37. The lower substrate 40 has a lower glass substrate 32, a transparent electrode 34, a second alignment layer 36, and a second polarizing plate 38. A liquid crystal material 41 is sandwiched between the upper substrate 39 and the lower substrate 40. The voltage is applied to the upper glass substrate 31 and the lower glass substrate 32 by the transparent electrode 33 and 34, so that the alignment of the liquid crystal material 41 is controlled. The first alignment layer 35 and the second alignment layer 36 perform so as to keep the alignment of the liquid crystal material 41 in initial condition during the no voltage application.

The image produced by the alignment-control for the liquid crystal material 41 transmits and intercepts incident light from the lower substrate 40. Then, a user see downward the upper substrate 39 identify the image.

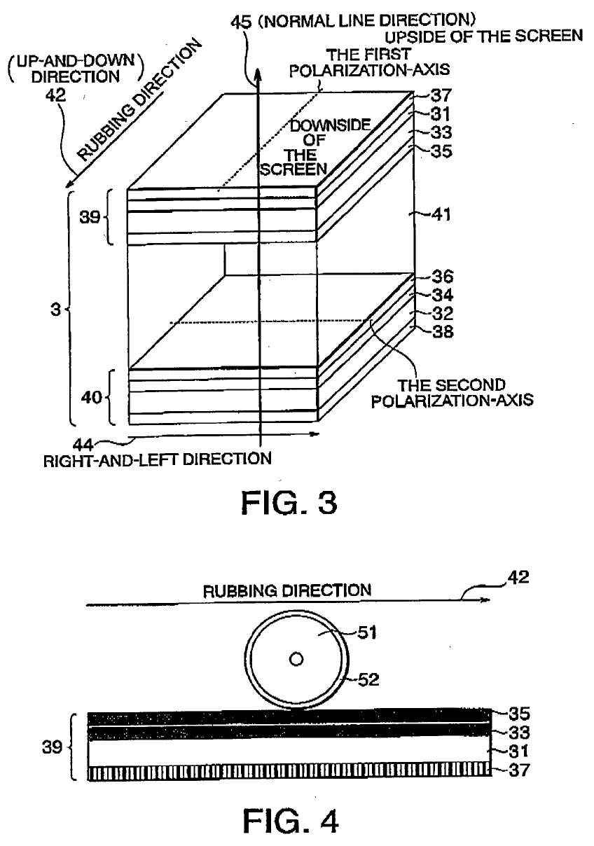

Referring to FIG. 3, the first polarizing plate 37 is arranged such that an up-and-down direction (indicated by the arrows 42 of FIG. 3) of the liquid crystal display 3 becomes its first polarization-axis direction of the first polarizing plate 37. The second polarizing plate 38 is arranged such that its second polarization-axis direction becomes rectangular for the first polarization-axis direction, for example a right-and-left direction (indicated by the arrows 44 of FIG. 3) of the liquid crystal display 3 becomes its second polarization-axis direction of the second polarizing plate 38.

The first alignment layer 35 formed in the upper substrate 39 is performed an, alignment-treatment by rubbing-treatment in the first polarization-axis direction, that is, an up-and-down direction of a screen. Similarly, the second alignment layer 36 formed in the lower substrate 40 is performed an alignment-treatment by rubbing-treatment in the second polarization-axis direction, that is, the right-and-left direction (indicated by the arrows 44 of FIG. 3) of a screen.

A liquid crystal material sandwiched between the upper substrate 39 and the lower substrate 40, and is closely fixed therein, by laminating two sheet of substrates such that each of first and second polarization-axis direction is rectangular each other and first polarization-axis direction becomes the up-and-down direction of a screen (indicated by the arrows 42 of FIG. 3), the up-and-down direction being the alignment direction by rubbing-treatment.

A direction of incident light in the liquid crystal display 3 becomes a direction from the lower substrate 40 to the upper substrate 39.

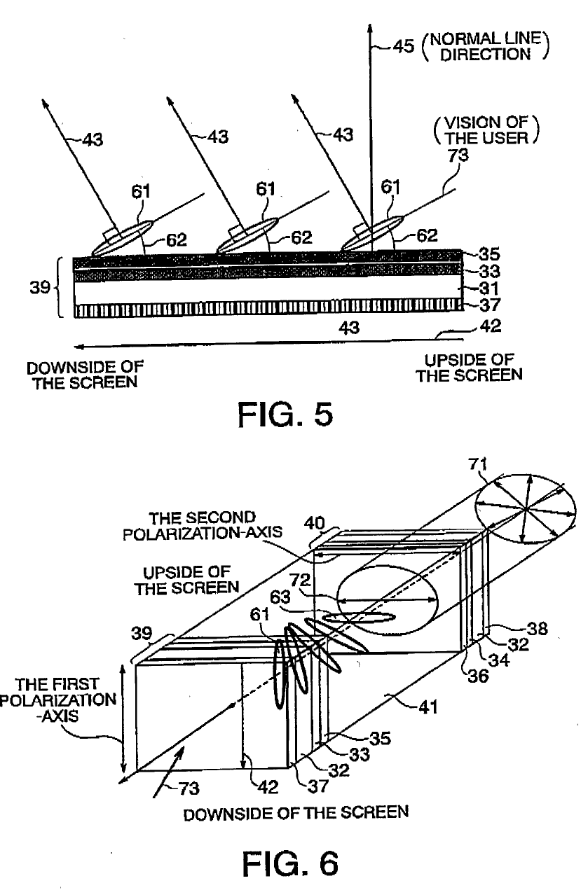

Next, the alignment direction by rubbing-treatment and the alignment direction of the liquid crystal material 41 according to an embodiment of the present invention will be described with reference to FIG. 4. FIG. 4 shows the rubbing-treatment process by use of the rubbing-treatment apparatus rubbing the first alignment layer 35 formed in the upper substrate 39 of the liquid crystal display 3 equipped with the terminal equipment according to the present invention. The rubbing-treatment apparatus has roller 51 to which the cloth is wound. When the first alignment layer 35 formed in the upper substrate 39 is rubbed by the roller 51, the first alignment layer 35 is scratched in the direction indicated by the arrows 42 of FIG. 3. Similarly, when the second alignment layer 36 formed in the lower substrate 40 is rubbed by the roller 51, the second alignment layer 36, is scratched in the direction indicated by the arrows 42 of FIG. 3. Then, the upper substrate 39 and the lower substrate 40 are laminated, and sandwich the liquid crystal material therebetween, the liquid crystal material is fixed. As shown FIG. 5, In such a case, first liquid crystal molecules 61 which exists in contact with the interface of the first alignment layer 35 (inside the upper substrate 39 opposite to the lower substrate 40) are aligned with a pretilt angle 62 for the laminated direction (indicated by the arrows 42 of FIG. 3) kept.

Next, the operation of the liquid crystal display apparatus will be described. At fast, referring to FIGS. 5 and 6, a viewing angle indicated by FIG. 1 will be described.

Generally, the liquid crystal molecule is a bar-like. A polarized light is transmitted inside the liquid crystal material from the lower substrate 40 to the upper substrate 39 while oscillating in a longer axis direction of the second liquid crystal molecules. The polarized light is polarized at random. The polarized light is emitted from outside the lower substrate 40.

Then, as shown FIG. 6, since the second polarizing plate 38 is laminated more outside the upper substrate 40, its second polarization-axis direction becomes rectangular for the first polarization-axis direction. Thus, the second polarization-axis direction becomes the right-and-left direction (indicated by the arrows 44 of FIG. 6). The incident light 71 oscillates parallel in the second polarization-axis direction of the second polarizing plate 38 so that the incident light 71 becomes polarized light 72. Second liquid crystal molecules 63 in contact with the interface of the second alignment layer 36 are aligned in the second polarization-axis direction of the second polarizing plate 38, that is, in the screen right-and-left direction (indicated by the arrows 44 of FIG. 3) of the liquid crystal display 3. Accordingly, the polarized light 72 is transmitted inside the liquid crystal material from the lower substrate 40 to the upper substrate 39 while oscillating in a longer axis direction of the second liquid crystal molecules 63.

The first liquid crystal molecules 61 in contact with the interface of the first alignment layer 35 are aligned such that the first alignment directions of the first liquid crystal molecules 61 are twisted by 90° for the second aligning directions of the first liquid crystal molecules 61. Since the first alignment layer 35 is arranged by rubbing such that its first polarization-axis direction becomes rectangular for the second polarization-axis direction in the second alignment layer 36, a first liquid crystal molecules 61 in contact with the interface of the first alignment layer 35 are aligned such that the first alignment directions (a longer axis directions) of the first liquid crystal molecules 61 are twisted by 90° for the second aligning directions (a longer axis directions) of the second liquid crystal molecules 63. Thus, the aligning direction of the liquid crystal molecules changes spirally from the second aligning directions to the first aligning directions. Accordingly, the polarization light oscillates to the longer axis directions of the molecules, that is, the polarization light oscillates in the longer axis directions of the liquid crystal molecules at the interface of the first alignment layer 35. The first polarization-axis direction of the first polarizing plate 37, the first alignment directions by rubbing, and the oscillating directions of the polarization light 72 are parallel each other. Therefore, the first polarizing plate 37 transmits the polarization light 72 and the polarization light 72 comes to the viewing direction of the user, so that a white display performs.

At this time, the first liquid crystal molecules 61 are aligned with a pretilt angle 62 for the rubbing treatment direction kept. Since the alignment-treatment performs in a direction from lower to upper of a screen in the liquid crystal display 3, the first liquid crystal molecules 61 is arranged with a pretilt angle 62 kept in an up direction of the screen.

As shown FIG. 5, when the first liquid crystal molecules 61 is raised depending on the pretilt angle 62, an oscillation of the polarized light 72 becomes to the maximum value at a part in a direction 43 perpendicular to the longer axis direction (the viewing direction of the user) 73 of the first liquid crystal molecules 61. Therefore, the viewing direction is below the normal line direction to the screen.

When the voltage is not applied to the upper glass substrate 31 and the lower glass substrate 32 by the transparent electrode 33 and 34, the liquid crystal material 41 aligns as described above and transmits the polarization light 72. When the voltage is not applied to the upper glass substrate 31 and the lower glass substrate 32 by the transparent electrode 33 and 34, the liquid crystal material 41 and the first and the second liquid crystal molecules 61 and 63 which are part thereof raise together. Therefore, a direction perpendicular to the longer axis direction of the first and the second liquid crystal molecules 61 and 63 become to the normal line direction to the screen. Accordingly, the incident light 71 and the polarization light 72 polarized by polarizing plate 38 can not be oscillated in the longer axis direction of the second liquid crystal molecules 63 in the interface of the second alignment layer 36. As a result, the polarization light 72 does not come to the viewing direction of the user through the upper substrate 39, so that a black display performs.

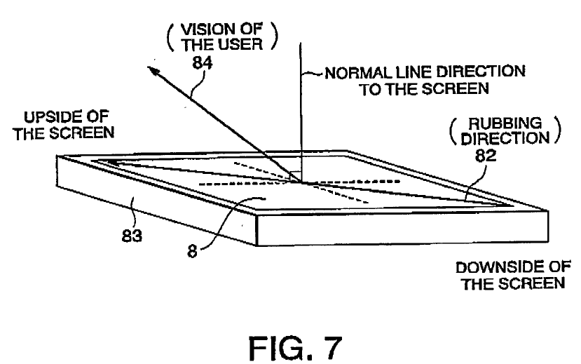

Next, another embodiment of the present invention will be described with reference to the FIG. 7. Referring to FIG. 7. the rubbing-treatment is performed to the upper substrate in the direction (indicated by the arrows 82 of FIG. 7) from lower right to upper left of a screen in the liquid crystal display 8. Therefore, the liquid crystal molecules exist adjacent to the interface of the alignment layer of the upper substrate is aligned with pretilt angle kept in an upper left direction of the screen. Accordingly, the viewing direction of the liquid crystal display 8 is broad in an upper left direction for the normal line direction. Thus, the terminal equipment 83 equipped with a liquid crystal display apparatus 8 provides the amelioration in the visibility, when an user utilizes the liquid crystal monitor such that the viewing direction of the user becomes to the direction from an upper left direction to a lower right direction.

According to the present invention, the amelioration in the visibility is provided corresponding to the viewing angle of the user, since the viewing angle is set in the rubbing direction corresponding to viewing direction easy to use. Therefore, the terminal equipment 83 equipped with a liquid crystal display apparatus 8 can be applied to the board type computer and the point of sale terminal (POS terminal).

What is claimed is:

1. A liquid crystal display apparatus comprising:
an upper substrate having a first alignment layer and a first polarization plate;
a lower substrate having a second alignment layer and a second polarization plate; and
a liquid crystal material sandwiched between the upper substrate and the lower substrate;
wherein the first polarizing plate is arranged such that an up-and-down direction of a screen in the liquid crystal display apparatus becomes its first polarization-axis direction, and
wherein the second polarizing plate is arranged such that its second polarization-axis direction becomes rectangular for the first polarization-axis direction, and
wherein the first alignment layer is aligned by rubbing-treatment in the first polarization-axis direction, and
wherein the second alignment layer is aligned by rubbing-treatment in the second polarization-axis direction.

2. The liquid crystal display apparatus as claimed in claim 1, wherein:
a second liquid crystal molecules in contact with the interface of the second alignment layer are aligned in the second polarization-axis direction.

3. The liquid crystal display apparatus as claimed in claim 2, wherein:
a polarized light emitted from the lower substrate is transmitted from the lower substrate to the upper substrate while oscillating in a longer axis direction of the second liquid crystal molecules.

4. The liquid crystal display apparatus as claimed in claim 3, wherein:
a first liquid crystal molecules in contact with the interface of the first alignment layer are aligned such that the first alignment directions of the first liquid crystal molecules are twisted by 90° for the second aligning directions of the first liquid crystal molecules.

5. The liquid crystal display apparatus as claimed in claim 4, wherein:
the first liquid crystal molecules moves spirally such that a longer axis thereof are twisted by 90° for the second aligning directions in the liquid crystal material.

6. The liquid crystal display apparatus as claimed in claim 5, wherein:
the first polarization-axis direction, a rubbing treatment direction, and a polarized light oscillating direction are parallel.

7. The liquid crystal display apparatus as claimed in claim 6, wherein:
the first liquid crystal molecules are arranged with a pretilt angle for the rubbing treatment direction kept.

8. The liquid crystal display apparatus as claimed in claim 7, wherein:
when the first liquid crystal molecules is raised depending on the pretilt angle, an oscillation of the polarized light becomes to the maximum value at a part in a direction perpendicular to the longer axis direction of the first liquid crystal molecules, the direction being a viewing direction of the liquid crystal display apparatus.

9. A liquid crystal display apparatus comprising;
an upper substrate having a first alignment layer and a first polarization plate;
a lower substrate having a second alignment layer and a second polarization plate; and
a liquid crystal material sandwiched between the upper substrate and the lower substrate,
wherein the first polarizing plate is arranged such that a direction from lower right to upper left of a screen in the liquid crystal display becomes its first polarization-axis direction, and
wherein the second polarizing plate is arranged such that its second polarization-axis direction becomes rectangular for the first polarization-axis direction, and
wherein the first alignment layer is aligned by rubbing-treatment in the first polarization-axis direction, and
wherein the second alignment layer is aligned by rubbing-treatment in the second polarization-axis direction.

10. A terminal equipment equipped with a liquid crystal display apparatus comprising:
an upper substrate having a first alignment layer and a first polarization plate;
a lower substrate having a second alignment layer and a second polarization plate; and
a liquid crystal material sandwiched between the upper substrate and the lower substrate,
wherein the first polarizing plate is arranged such that an up-and-down direction of a screen in the liquid crystal display apparatus becomes its first polarization-axis direction, and
wherein the second polarizing plate is arranged such that its second polarization-axis direction becomes rectangular for the first polarization-axis direction, and
wherein the first alignment layer is aligned by rubbing-treatment in the first polarization-axis direction, and
wherein the second alignment layer is aligned by rubbing-treatment in the second polarization-axis direction.
